(19) United States
(12) Patent Application Publication
(10) Pub. No.: US 2025/0085424 A1
(43) Pub. Date: Mar. 13, 2025

(54) FREQUENCY SWEEP CHARACTERISTIC MEASUREMENT DEVICE, LIDAR DEVICE, AND FREQUENCY SWEEP CHARACTERISTIC MEASUREMENT METHOD

(71) Applicant: DENSO CORPORATION, Kariya-city (JP)

(72) Inventors: Chihiro MORIGUCHI, Kariya-city (JP); Naoki YOSHIMOTO, Kariya-city (JP); Tetsuya SHIMOGAKI, Nagakute-shi (JP); Tatsuya YAMASHITA, Nagakute-shi (JP); Makoto NAKAI, Nagakute-shi (JP)

(21) Appl. No.: 18/955,708

(22) Filed: Nov. 21, 2024

Related U.S. Application Data
(63) Continuation of application No. PCT/JP2023/018182, filed on May 15, 2023.

(30) Foreign Application Priority Data
May 23, 2022 (JP) 2022-084179

(51) Int. Cl. G01S 17/34; G01S 7/4915; G01S 17/36; G01S 17/931

(52) U.S. Cl. CPC G01S 17/34; G01S 7/4915; G01S 17/36; G01S 17/931

(57) ABSTRACT

A frequency sweep characteristic measurement device splits the laser light to generate a difference in lengths of optical paths and combines the split laser lights to generate a combined light. This device receives the combined light, converts the received light into a beat signal, and outputs the beat signal. Further, this device adjusts a waveform so that an amplitude and a phase match at both ends of the beat signal, calculates a quadrature component by performing a Hilbert transform on the beat signal whose waveform has been adjusted, and calculates an instantaneous phase of the beat signal by calculating an inverse tangent of the quadrature component and the beat signal whose waveform has been adjusted. This device calculates the frequency sweep characteristic of the laser light based on the instantaneous phase and the difference in the lengths of the optical paths.

### CROSS-REFERENCE TO RELATED APPLICATION

The present application is a continuation application of International Application No. PCT/JP2023/018182, filed on May 15, 2023, which claims priority to Japanese Patent Application No. 2022-084179, filed in Japan on May 23, 2022. The contents of these applications are incorporated herein by reference in their entirety.

### BACKGROUND

### 1. Technical Field

The present disclosure relates to a frequency sweep characteristic measurement device and a frequency sweep characteristic measurement method. The present disclosure also relates to a FMCW-based LiDAR device.

### 2. Related Art

LiDAR (Light Detection and Ranging) is a technology that uses a laser light to detect an object and measure the distance to the detected object. There are two types of distance measurement methods of the LiDAR: a TOF (Time of Flight) method and an FMCW (Frequency Modulated Continuous Wave) method. The FMCW method is a technology that modulates the frequency of light as a triangular wave and measures a distance to an object and a velocity of the object based on beat signals arising from a reference light and a received light.

The frequency of a laser light is swept by sweeping an input current as the triangular wave. However, due to the heat dissipation characteristics of the laser and the change in carrier concentration associated with the input current, a graph of a time characteristic of the frequency (hereinafter “a frequency sweep characteristic”) shows a nonlinear curve with respect to time. When there are few nonlinear components, the frequency of the beat signal is substantially constant, and a spectral width is narrow. Therefore, high sensitivity and high resolution are achieved (see FIG. 8). On the other hand, when there are many nonlinear components, the frequency of the beat signal is broadened, and the spectral width is expanded. This results in low sensitivity and low resolution (see FIG. 9).

In addition, a frequency characteristic of the laser changes due to temperature changes in the surrounding environment. Therefore, it is necessary to analyze the frequency sweep characteristic of the laser continuously or periodically and correct the frequency sweep characteristic to be linear.

### SUMMARY

The present disclosure provides a frequency sweep characteristic measurement device. As an aspect of the present disclosure, a frequency sweep characteristic measurement device for measuring a frequency sweep characteristic of a laser light in which a frequency is swept, includes an asymmetric Mach-Zehnder interferometer, a photodetector, a waveform adjustment unit, a Hilbert transform unit, an instantaneous phase calculation unit, and a frequency calculation unit. The asymmetric Mach-Zehnder interferometer splits the laser light to generate a difference in lengths of optical paths and combines the split laser lights to generate a combined light. The photodetector receives the combined light output from the asymmetric Mach-Zehnder interferometer, converts the received light into a beat signal as an electrical signal, and outputs the beat signal. The waveform adjustment unit adjusts a waveform so that an amplitude and a phase match at both ends of the beat signal. The Hilbert transform unit calculates a quadrature component by performing a Hilbert transform on the beat signal whose waveform has been adjusted. The instantaneous phase calculation unit calculates an instantaneous phase of the beat signal by calculating an inverse tangent of the quadrature component calculated by performing the Hilbert transform and the beat signal whose waveform has been adjusted. The frequency calculation unit calculates the frequency sweep characteristic of the laser light based on the instantaneous phase and the difference in the lengths of the optical paths.

### BRIEF DESCRIPTION OF THE DRAWINGS

In the accompanying drawings:

FIG. 1 is a diagram showing a configuration of an FMCW-based LiDAR device including a frequency sweep characteristic measurement device according to a first embodiment;

FIG. 2 is a graph showing an analysis result of the frequency sweep characteristic and an analysis result of a nonlinear component of an instantaneous frequency, when a waveform is discontinuous at both ends of a beat signal;

FIG. 3 is a graph showing the analysis result of the frequency sweep characteristic and the analysis result of the nonlinear component of the instantaneous frequency, when the waveform is continuous at both ends of the beat signal;

FIGS. 4A to 4C are illustrative diagrams showing how to adjust the waveform to be continuous at both ends of the beat signal;

FIG. 5 is a diagram showing a configuration of an FMCW-based LiDAR device including a frequency sweep characteristic measurement device according to a second embodiment;

FIG. 6 is a diagram showing a configuration of an asymmetric MZI with a control mechanism for a difference in lengths of optical paths;

FIG. 7 is a graph showing a relationship between the difference ΔL in lengths of optical paths (length of the delay optical fiber) and a maximum value of the nonlinear component νnl of the instantaneous frequency;

FIG. 8 is an illustrative diagram showing a case where there are a few nonlinear components of the frequency sweep characteristic; and

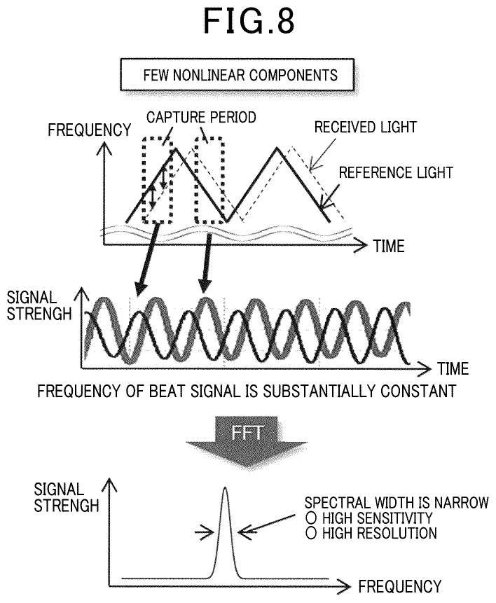

FIG. 9 is an illustrative diagram showing a case where there are many nonlinear components of the frequency sweep characteristic.

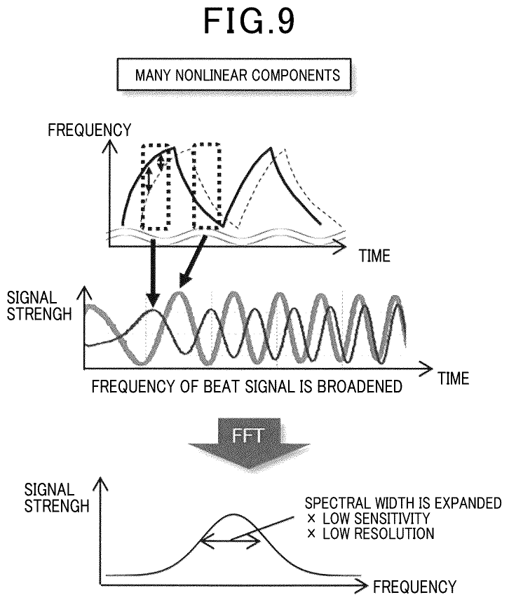

### DETAILED DESCRIPTION OF THE PREFERRED EMBODIMENTS

Non-patent literature 1 (hereinafter referred to as “NPTL 1”) describes one method to improve the linearity of the frequency sweep characteristic as follows. First, an electromagnetic wave is passed through an asymmetric Mach-Zehnder interferometer, and then the electromagnetic wave is received by a photodetector to generate a beat signal. A Hilbert transform is then performed to the beat signal to measure a quadrature component (Q component). Next, an arctangent on the quadrature component and an original beat signal (I component) is calculated. This calculates an instantaneous phase of the beat signal. Then, the frequency sweep characteristic of the laser is calculated based on the instantaneous phase of the beat signal using an approximate expression by a Taylor expansion. A voltage update algorithm updates the input signal to the laser using the calculated frequency sweep characteristic. This corrects the frequency sweep characteristic to be linear. Here, to minimize the effect of non-ideal transitions, 20% of the beat signals from both ends of a beat frequency are not used for input to the voltage update algorithm, and the remaining 80% of the beat signals are input to the voltage update algorithm.

[NPTL 1] X. Zhang, J. Pouls, and M. C. Wu, “Laser frequency sweep linearization by iterative learning pre-distortion for FMCW LiDAR,” Optics Express, 27 (7) 9965 (2019).

However, the method described in NPTL 1 limits the ROI (Region of Interest; a region in which the frequency sweep characteristic is analyzed) of the beat signal to 80% of a total region. This is due to the following reasons. Distortions (large offsets and ripples) at both ends of a quadrature signal caused by the Hilbert transform result in non-ideal transitions. Therefore, the distortions at both ends of the quadrature signal are not included in a calculation of the frequency sweep characteristic. In this regard, the method in NPTL 1 cannot sufficiently linearize the 20% region outside of the region in which the frequency sweep characteristic is analyzed. Thus, it cannot use a part of the signal to measure a distance. As a result, the method in NPTL 1 would cause a decrease in detection sensitivity.

Multiplying by a window function can improve the distortions at both ends of the quadrature signal. However, the improvement is limited, and errors occur in the measurement results. In addition, the method using the window function brings an amplitude near both ends of the quadrature signal close to zero, so errors due to other factors, such as atmospheric disturbances, are likely to increase.

Another possible method for obtaining a quadrature component of the beat signal is to use a quadrature detection. However, the quadrature detection requires an expensive device, such as an acousto-optic frequency shifter, which requires additional components.

An object of the present disclosure is to provide a frequency sweep characteristic measurement device capable of accurately measuring the frequency sweep characteristic of the light.

An aspect of the present disclosure is a frequency sweep characteristic measurement device for measuring a frequency sweep characteristic of a laser light in which a frequency is swept. This device includes: an asymmetric Mach-Zehnder interferometer that splits the laser light to generate a difference in lengths of optical paths and combines the split laser lights to generate a combined light; a photodetector that receives the combined light output from the asymmetric Mach-Zehnder interferometer, converts the received light into a beat signal as an electrical signal, and outputs the beat signal; a waveform adjustment unit that adjusts a waveform so that an amplitude and a phase match at both ends of the beat signal; a Hilbert transform unit that calculates a quadrature component by performing a Hilbert transform on the beat signal whose waveform has been adjusted; an instantaneous phase calculation unit that calculates an instantaneous phase of the beat signal by calculating an inverse tangent of the quadrature component calculated by performing the Hilbert transform and the beat signal whose waveform has been adjusted; and a frequency calculation unit that calculates the frequency sweep characteristic of the laser light based on the instantaneous phase and the difference in the lengths of the optical paths.

The frequency sweep characteristic measurement device of the present disclosure may have a configuration as follows. The waveform adjustment unit, to adjust the waveform so that the amplitude and the phase match at both ends of the beat signal, extracts two adjacent zero-crossing points in a vicinity of both ends of the beat signal, respectively, calculates derivative values of the beat signal at the four extracted zero-crossing points, selects two points of the four extracted zero-crossing points where signs of the calculated derivative values match each other, and deletes measurement points outside the two selected points from the beat signal.

The frequency sweep characteristic measurement device of the present disclosure may have a configuration as follows. The asymmetric Mach-Zehnder interferometer is configured such that the difference in the lengths of the optical paths is controllable. The waveform adjustment unit, to adjust the waveform so that the amplitude and the phase at both ends of the beat signal match, controls the difference in the lengths of the optical paths.

The frequency sweep characteristic measurement device of the present disclosure may have a configuration as follows. The asymmetric Mach-Zehnder interferometer comprises an optical path switching device that switches multiple optical paths that are the different in the length of the optical path from each other, and is configured such that the difference in the lengths of the optical paths is controllable by the optical path switching device switching the multiple optical paths. The waveform adjustment unit, to adjust the waveform so that the amplitude and the phase at both ends of the beat signal match, controls the selection of the optical path by optical path switching device.

Another aspect of the present disclosure is an FMCW-based LiDAR device including a laser diode emitting a laser light, and a frequency sweep characteristic measurement device as described above. The drive signal control unit, to reduce a nonlinear component of the laser light, calibrates a drive signal of the laser diode based on the frequency sweep characteristic of the laser light calculated by the frequency calculation unit.

Another aspect of the present disclosure is a frequency sweep characteristic measurement method for measuring a frequency sweep characteristic of a laser light in which a frequency is swept. This method includes following steps of: splitting the laser light to generate a difference in lengths of optical paths and combining the split laser lights to generate a combined light; receiving the combined light, converting the received light into a beat signal as an electrical signal, and outputting the beat signal; adjusting a waveform so that an amplitude and a phase match at both ends of the beat signal; calculating a quadrature component by performing a Hilbert transform on the beat signal whose waveform has been adjusted; calculating an instantaneous phase of the beat signal by calculating an inverse tangent of the quadrature component calculated by performing the Hilbert transform and the beat signal whose waveform has been adjusted; and calculating the frequency sweep characteristic of the laser light based on the instantaneous phase and the difference in the lengths of the optical paths.

A technology provided by the present disclosure enables accurate measurement of the frequency sweep characteristic of the light.

The above-described object and other objects as well as the characteristics and advantages of the present disclosure will be further clarified by the following detailed description with reference to the accompanying drawings.

The embodiments of the present disclosure will be described with reference to the drawings.

### First Embodiment

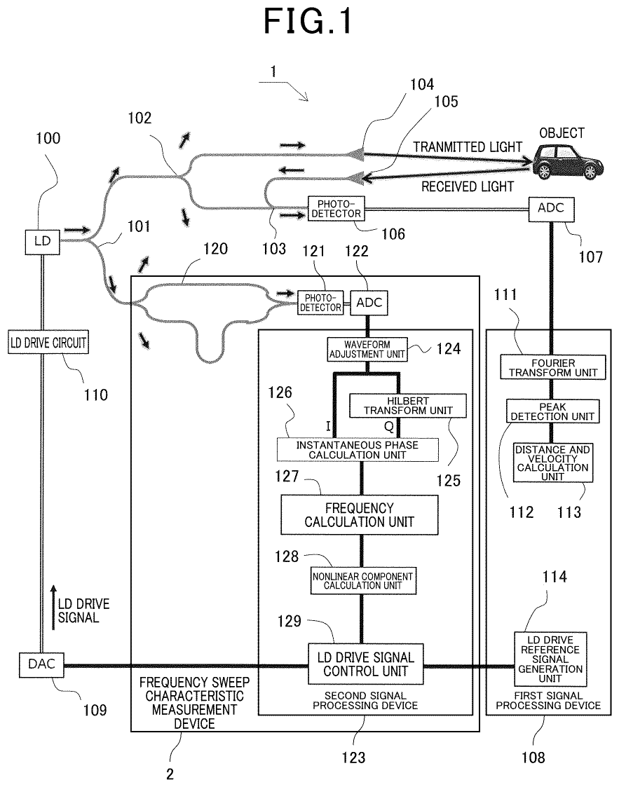

FIG. 1 is the diagram showing the configuration of the FMCW-based LiDAR device including the frequency sweep characteristic measurement device according to the present embodiment. The FMCW-based LiDAR device of the present embodiment can measure a frequency sweep characteristic in real time to linearly calibrate the frequency sweep characteristic.

As shown in FIG. 1, the FMCW-based LiDAR device of the present embodiment is configurated to include a LiDAR device 1 and a frequency sweep characteristic measurement device 2. The LiDAR device 1 is configured to include a laser diode (LD) 100, optical couplers 101 to 103, an optical transmitting antenna 104, an optical receiving antenna 105, a photodetector 106, an AD converter 107, a first signal processing device 108, a DA converter 109, and an LD driving circuit 110. The frequency sweep characteristic measurement device 2 is configurated to include an asymmetric MZI (an asymmetric Mach-Zehnder interferometer) 120, a photodetector 121, an AD converter 122, and a second signal processing device 123.

### Configuration of LiDAR Device 1

First, each configuration of the LiDAR device 1 is described.

The LD 100 is a frequency-tunable laser diode, which emits a laser light. The frequency is controlled by the LD drive circuit 110. The time characteristic of the frequency (that is, the frequency sweep characteristic) is controlled so that a triangular-shaped waveform repeats periodically. In other words, the frequency is controlled to repeat intervals in which the frequency increases linearly with time and intervals in which the frequency decreases linearly with time. A wavelength band of the laser light is arbitrary. The wavelength band of the laser light may be in an infrared band.

The optical coupler 101 is an optical device that splits the laser light emitted from the LD 100 into two laser lights (that is, two light beams). One of the two split laser lights (that is, one of the two split light beams) is input to the optical coupler 102. The other of the split laser light is input to the asymmetric MZI 120.

The optical coupler 102 is an optical device similar to the optical coupler 101. The optical coupler 102 is an optical device that splits the laser light from the optical coupler 101 into a transmitted light and a reference light. The transmitted light is input to the optical transmit antenna 104. The reference light is input to the optical coupler 103.

The optical transmitting antenna 104 is an optical device that emits the transmitted light input from the optical coupler 102 onto an object.

The optical receiving antenna 105 is an optical device that receives the transmitted light (received light) reflected by the object. The received light is input to the optical coupler 103.

The optical coupler 103 is an optical device that combines the reference light input from the optical coupler 102 and the received light input from the optical receiving antenna 105 to output the combined light.

The photodetector 106 is a device that receives the combined light input from the optical coupler 103, converts the received light into an electrical signal, and generates and outputs a beat (beat signal) caused by interference between the reference light and the received light. The photodetector 106 may be a Ge photodiode. The photodetector 106 is preferably a differential-type balance detector. Alternatively, it is preferable to provide a filter to cut DC components between the photodetector 106 and the AD converter 107.

The AD converter 107 is a device that converts the beat signal input from the photodetector 106 from an analog signal to a digital signal, for output.

The first signal processing device 108 calculates a distance to the object and a relative velocity of the object by executing a predetermined signal processing on the beat signal output from the AD converter 107. The first signal processing device 108 generates an LD drive signal to drive the LD 100. The first signal processing device 108 is configured to serve as a Fourier transform unit 111, a peak detection unit 112, a distance and velocity calculation unit 113, and an LD drive reference signal generation unit 114. These functions and processing are described below. The first signal processing device 108 is configured to include at least one or more processors, one or more memories, and one or more communication I/Fs. The first signal processing device 108 can be a signal processing device in which the processor, the memory, and the communication I/F are configured to communicate with each other via a bus. In such a configuration, the first signal processing device 108 can realize one or more of the above functions by, for example, the processor reading and executing a program stored in the memory corresponding to a non-transitory computer-readable storage medium. In other words, the program contains a set of processor-executable instructions to realize the functions of the Fourier transform unit 111, the peak detection unit 112, the distance and velocity calculation unit 113, and the LD drive reference signal generation unit 114. The first signal processing device 108 may be composed of one or more integrated circuits (ASIC: Application Specific Integrated Circuit). Furthermore, the first signal processing device 108 may be combined with a signal processing device composed of at least one or more processors, one or more memories, and one or more communication I/Fs and a signal processing device composed of one or more integrated circuits.

The DA converter 109 is a device that converts the LD drive signal input from the second signal processing device 123 from the digital signal to the analog signal, for output.

The LD drive circuit 110 controls a frequency of the laser light emitted by the LD 100 based on the LD drive signal input from the DA converter 109. Specifically, the LD drive circuit 110 controls the frequency by controlling an input current to the LD 100.

### Configuration of Frequency Sweep Characteristic Measurement Device 2

Next, each configuration of the frequency sweep characteristic measurement device 2 is described.

The asymmetric MZI 120 is an optical device that splits the laser light input from the optical coupler 101 into two laser lights, generates a difference ΔL in lengths of optical paths, and then combines the two split laser lights.

The photodetector 121 is a device that receives the combined light output from the asymmetric MZI 120, converts the received light into an electrical signal, and generates and outputs the beat signal caused by the interference of two light beams that produce the difference ΔL in the lengths of the optical paths. The photodetector 121 may be the Ge photodiode. The photodetector 121 is preferably a differential-type balance detector. Alternatively, it is preferable to provide the filter to cut the DC components between the photodetector 121 and the AD converter 122.

The asymmetric MZI 120 and the photodetector 121 may be implemented together as a single optical integrated circuit. With this configuration, it is possible to achieve a simplified configuration and lower cost. An optical waveguide in the optical integrated circuit is Si, SiN, or the like. A part of the asymmetric MZI 120 to the photodetector 121 may be implemented as the optical integrated circuit.

The AD converter 122 is a device that converts the beat signal input from the photodetector 121 from the analog signal to the digital signal, for output.

The second signal processing device, 123 calculates the frequency sweep characteristic of the laser light output from the LD 100 by executing the predetermined signal processing on the beat signal input from the AD converter 122 to calculate a nonlinear component. The second signal processing device 123, is configured to serve as a waveform adjustment unit 124, a Hilbert transform unit 125, an instantaneous phase calculation unit 126, a frequency calculation unit 127, a nonlinear component calculation unit 128, and an LD drive signal control unit 129. These functions and processing are described below. The second signal processing device 123 is configured to include at least one or more processors, one or more memories, and one or more communication I/Fs. The second signal processing device 123 can be the signal processing device in which the processor, the memory, and the communication I/F are configured to communicate with each other via the bus. In such a configuration, the second signal processing device 123 can realize one or more of the above functions by, for example, the processor reading and executing the program stored in the memory corresponding to the non-transitory computer-readable storage medium. In other words, the program contains a set of processor-executable instructions to realize the functions of the waveform adjustment unit 124, the Hilbert transform unit 125, the instantaneous phase calculation unit 126, the frequency calculation unit 127, the nonlinear component calculation unit 128, and the LD drive signal control unit 129. The second signal processing device 123 may be composed of one or more integrated circuits. Furthermore, the second signal processing device 123 may be combined with the signal processing device composed of at least one or more processors, one or more memories, and one or more communication I/Fs and the signal processing device composed of one or more integrated circuits.

### Processing of LiDAR Device 1

Next, the processing of the FMCW-based LiDAR device is described. First, a distance measurement processing of the LiDAR device 1 is explained.

The LD drive circuit 110 drives the LD 100 based on the LD drive signal input from the second signal processing device 123, and controls the frequency sweep characteristic of the laser light emitted by the LD 100 so that the triangular waveform repeats periodically. Here, the LD drive signal is an LD drive reference signal generated by the LD drive reference signal generation unit 114 and corrected by the LD drive signal control unit 129 of the second signal processing device 123. The LD drive reference signal is a signal whose voltage value repeatedly changes in the triangular waveform.

The optical coupler 101 then splits the laser light emitted from the LD 100 into two laser lights. The optical coupler 102 further splits the laser light from the optical coupler 101 into the reference light and the transmitted light. The transmitted light is emitted through the optical transmitter antenna 104 onto the object. The transmitted light then is reflected by the object. The reflected light is received by the optical receiving antenna 105. The optical coupler 103 combines the reference light split by the optical coupler 102 and a received light received by the optical receiving antenna 105. The photodetector 106 converts the combined light into the electrical signal and generates the beat signal.

Next, the AD converter 107 converts the beat signal from the analog signal to the digital signal. The first signal processing device 108 executes the signal processing on the signal (beat signal) input from the AD converter 107 to calculate the distance to the object and the relative velocity of the object. The signal processing executed by the first signal processing device 108 is specifically as follows. In the present embodiment, the signal processing by each function realized by the processor in the first signal processing device 108 executing the program is described below.

First, the Fourier transform unit 111 performs a Fourier transform of the input beat signal and calculates a frequency spectrum of the beat signal (STEP 11). Next, the peak detection unit 112 detects the frequency of a peak in the calculated frequency spectrum (STEP 12). In this way, the first signal processing device 108 obtains a frequency of the beat signal in an interval where the frequency increases linearly and a frequency of the beat signal in an interval where the frequency decreases linearly (detecting the frequencies of the two beat signals). The distance and velocity calculation unit 113 then calculates the distance to the object and the relative velocity of the object based on the frequencies of the two detected beat signals (STEP 13).

### Processing of Frequency Sweep Characteristic Measurement Device 2

Next, the processing of the frequency sweep characteristic measurement device 2 is described.

One of the laser lights (one of the split light beams), split into two laser lights (two light beams) by the optical coupler 101, passes through the asymmetric MZI 120. The photodetector 121 then receives the laser light that has passed through the asymmetric MZLI 120 and generates the beat signal. The AD converter 122 converts the generated beat signal from the analog signal to the digital signal. The second signal processing device 123 executes the signal processing on the signal (beat signal) input from the AD converter 122 to calculate the frequency sweep characteristic of the laser light and the nonlinear component. The signal processing executed by the second signal processing device 123 is specifically as follows. In the present embodiment, the signal processing by each function realized by the processor in the second signal processing device 123 executing the program is described below.

First, the waveform adjustment unit 124 adjusts a waveform to be continuous at both ends of the input beat signal (STEP 21). In other words, the waveform adjustment unit 124 adjusts the waveform so that an amplitude and a phase match at both ends of the beat signal. The specific waveform adjustment method is as follows.

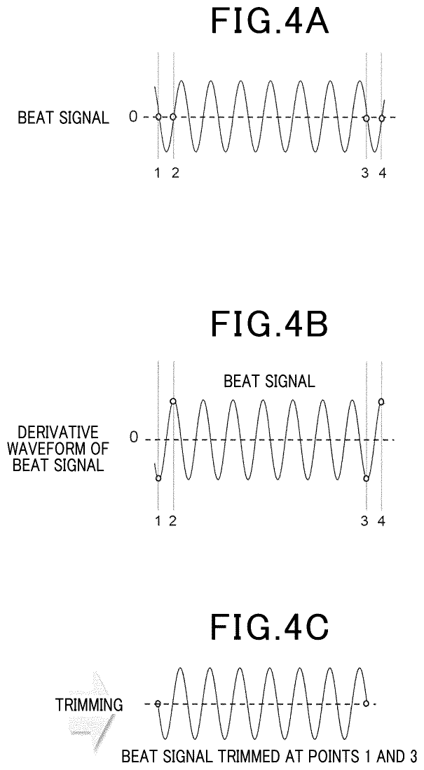

First, the waveform adjustment unit 124 removes high-frequency noise from the beat signal by a moving average (STEP 21-1). The waveform adjustment unit 124 then extracts two adjacent zero-crossing points (four points of zero amplitude) in a vicinity of both ends of the beat signal, respectively (STEP 21-2) (see FIG. 4A). The zero-crossing point can be easily extracted by using a balance detector serving as the photodetector 121 or by using a DC block filter, to cut the DC component.

Next, the waveform adjustment section 124 calculates derivative values of the beat signals at the four extracted zero-crossing points (STEP 21-3). Then, the waveform adjustment unit 124 selects two points of the four zero-crossing points where signs of the derivative values match each other (STEP 21-4) (see FIG. 4B). That is, the waveform adjustment unit 124 selects either two points with a sign of + (plus) or two points with a sign of − (minus). In the example shown in FIG. 4B, the points 1 and 3 or 2 and 4 are selected.

Next, the waveform adjustment unit 124 deletes measurement points outside the two selected points from the beat signal, for trimming (STEP 21-5) (see FIG. 4C). In the example shown in FIG. 4C, the waveform adjustment unit 124 selects two points 1 and 3 of the four zero-crossing points and deletes the measurement points outside the selected two points. Accordingly, the configuration of the present embodiment can adjust the waveform so that the amplitude and the phase match at both ends of the beat signal. In addition, this configuration minimizes a region where the waveform of the beat signal is trimmed.

The waveform adjustment method of the beat signal is not limited to the above method. The waveform adjustment method of the beat signal only needs to extract, by a voluntary method, the points where the amplitude and the phase match in the vicinity of both ends of the beat signal and then delete the measurement points outside the extracted points from the beat signal. According to the above method in the present embodiment, the points where the amplitude and the phase match in the vicinity of both ends of the beat signal can be easily extracted. Note that it is not necessary to match the amplitude and the phase perfectly. A few errors are allowed to the extent that the purpose of the present disclosure can be achieved (to the extent that the technical advantages of the present disclosure are achieved). For example, an error is allowed such that an absolute value of a difference between the amplitudes at both ends of the beat signal is 1% or less of a maximum value of the amplitude. An error is allowed such that an absolute value of a difference between the phases at both ends of the beat signal is 0.01 π or less.

Next, the Hilbert transform unit 125 performs a Hilbert transform on the beat signal whose waveform has been adjusted and calculates a quadrature component (Q component) (STEP 22). Here, the waveform is adjusted to be continuous at both ends of the beat signal before performing the Hilbert transform. Therefore, a distortion of the Q component at both ends and a distortion at a boundary between up and down intervals of the frequency are reduced.

Next, the instantaneous phase calculation unit 126 calculates an instantaneous phase φb(t) of the beat signal (STEP 23). The instantaneous phase φb(t) of the beat signal is obtained by calculating an inverse tangent of an I component of the beat signal whose waveform has been adjusted and the quadrature component (Q component of the beat signal) calculated by performing the Hilbert transform. That is, the instantaneous phase φb(t) of the beat signal is obtained by calculating φb(t)=arctan(Q/I). The instantaneous phase of the beat signal obtained by the above calculation is a waveform folded back by ±π. Therefore, the instantaneous phase calculation unit 126 performs unwrapping.

Next, the frequency calculation unit 127 calculates an instantaneous frequency ν(t) of the beat signal based on the instantaneous phase φb(t) of the beat signal (STEP 24). In other words, the frequency calculation unit 127 calculates the frequency sweep characteristic of the laser light. The instantaneous frequency ν(t) is obtained by differentiating the instantaneous phase φb(t). Specifically, the instantaneous frequency ν(t) is obtained by calculating 2πν(t)=d(φb(t))/dt. By the Taylor expansion of φb(t−τ) by τ to a first-order approximation, the above equation becomes ν(t)=φb(t)/(2πτ). τ is a propagation delay time in the asymmetric MZI 120, where τ=ΔL/c. ΔL is the difference in the lengths of the optical paths, and c is the velocity of the light. A value of t is a range of 1 ns or more and 100 ns or less, which is sufficiently small. Therefore, the above differential equation can be approximated as above. The frequency calculation unit 127 uses the above approximate equation to calculate the instantaneous frequency ν(t), i.e., the frequency sweep characteristic of the laser light.

Next, the nonlinear component calculation unit 128 calculates the nonlinear component of the calculated instantaneous frequency ν(t) (STEP 25). ν(t) is expressed as ν(t)=γt+νnl(t). γ is a rate of change of the frequency, νnl(t) is the nonlinear component of the instantaneous frequency ν(t), and γ is a known value. Therefore, the nonlinear component calculation unit 128 calculates the nonlinear component νnl(t) of the instantaneous frequency ν(t) by using the above equation.

Next, the LD drive signal control unit 129 calibrates the LD drive reference signal input from the first signal processing unit 108 (LD drive reference signal generation unit 114) based on the calculated nonlinear component νnl(t) to generate the LD drive signal (STEP 26). Specifically, the LD drive signal control unit 129 adds the distortion corresponding to the nonlinear component νnl(t) to the LD drive reference signal to generate the LD drive signal. Thus, the LD drive signal control unit 129 subtracts in advance the nonlinear component in the frequency sweep characteristic of the laser light emitted by the LD 100. The LD drive circuit 110 drives the LD 100 according to the LD drive signal corrected in this way. This makes it possible to reduce the nonlinear component in the frequency sweep characteristic of the laser light.

The correction of the LD drive reference signal may be performed constantly or as needed.

As described above, in the frequency sweep characteristic measurement device 2 of the present embodiment, the waveform adjustment unit 124 adjusts the waveform so that the waveform is continuous at both ends of the beat signal. The frequency calculation unit 127 then calculates the instantaneous frequency of the beat signal, i.e., the frequency sweep characteristic of the laser light, based on the instantaneous phase of the beat signal whose waveform has been adjusted. As a result, the frequency sweep characteristic measurement device 2 of the present embodiment can accurately measure the frequency sweep characteristic of the laser light. Therefore, the FMCW-based LiDAR device can improve the linearity of the sweep frequency of the laser light by correcting the sweep frequency of the laser light using the measured frequency sweep characteristic. As a result, the FMCW-based LiDAR device in the present embodiment can improve distance measurement performance. In addition, the FMCW-based LiDAR device in the present embodiment has an ROI (the region where the frequency sweep characteristic is analyzed) of the beat signal that is wider than the ROI in the conventional method. The FMCW-based LiDAR device in the present embodiment has a wide range of laser light that can be calibrated; thus, its sensitivity and resolution (distance resolution) can be improved. The FMCW-based LiDAR device can also measure the frequency sweep characteristic of the laser light without using the expensive device such as a frequency shifter. Therefore, the FMCW-based LiDAR device of the present embodiment can achieve the lower cost. The FMCW-based LiDAR device of the present disclosure may be installed in a vehicle and used to measure a distance between the vehicle and an object existing around the vehicle. This allows the vehicle to provide various driving/traveling assistance, such as avoiding or mitigating collisions with the object, based on the distance between the vehicle and the object. The FMCW-based LiDAR device outputs the measured distance between the object and the vehicle to an Electronic Control Unit (ECU) installed in the vehicle. The ECU is composed, for example, of a computer including at least one or more processors and at least one or more memories, as well as a peripheral device such as a communication I/F. Accordingly, the ECU is configured to communicate with the FMCW-based LiDAR device. Based on measurement results input from the FMCW-based LiDAR device, the ECU generates a control signal for the driving/traveling assistance and outputs the control signal to various control devices that control vehicle driving/traveling. For example, in a configuration that provides driving assistance, such as collision mitigation or collision avoidance, the ECU outputs the control signal to a control device that controls a brake actuator and a control device that controls a steering wheel. The various control devices then control the drive of the controlled device according to the input control signal. As a result, the vehicle can perform driving control, such as braking control and steering control, to mitigate or avoid collisions. Thus, the technology of the present disclosure is useful for vehicle driving/traveling assistance, etc. In addition, the technology of the present disclosure can improve the sensitivity and resolution of the FMCW-based LiDAR device, which can realize vehicle driving/driving assistance based on accurate measurement results.

Next, an analysis result of the beat signal for the present embodiment is explained.

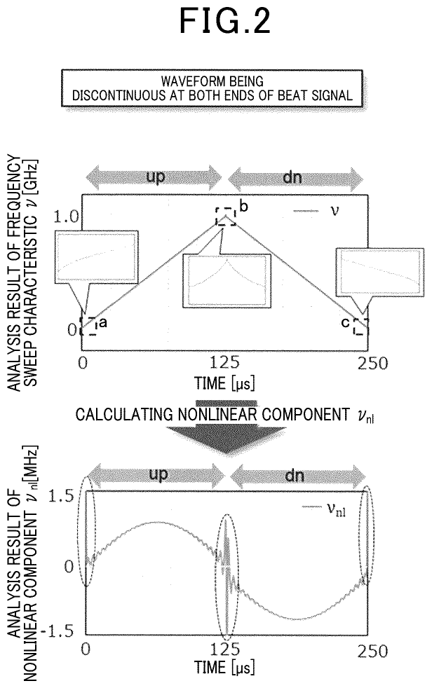

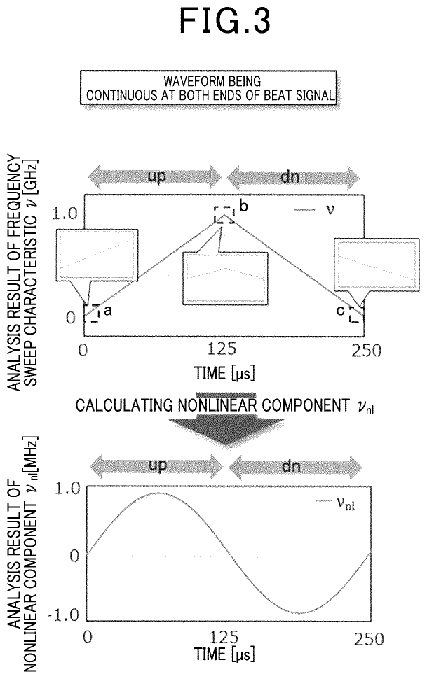

In the present embodiment, the beat signal: V(t)∝cos[πν(t)τ] was generated with the rate of change of the frequency of γ=1.0 GHz/125 μs and the nonlinear component of the instantaneous frequency of νnl(t)=9×10⁵·sin[2π·4×10³ t]. The frequency sweep characteristic of the laser light was then analyzed by the beat signal generated in this embodiment. Note that, by adjusting τ, a beat signal with a discontinuous waveform at both ends and a beat signal with a continuous waveform were generated, respectively. A length of a fundamental oscillation wave of the laser light was set to 1550 nm. FIGS. 2 and 3 are graphs showing an analysis result of the frequency sweep characteristic of the laser light and an analysis result of the nonlinear component of the instantaneous frequency. The graph of FIG. 2 shows the analysis result when the waveform is discontinuous at both ends of the beat signal. The graph of FIG. 3 shows the analysis result when the waveform is continuous at both ends of the beat signal.

As shown in FIG. 2, when the waveform is discontinuous at both ends of the beat signal, a steep offset occurs at a boundary ‘b’ between the up interval “up” and the down interval “dn” of the frequency, and at both ends ‘a’ and ‘c’ of the frequency. Ripples continuously occur in front and behind the offset. In other words, the frequency sweep characteristics of the laser light cannot be measured accurately at the boundary ‘b’ between the up interval “up” and the down interval “dn” of the frequency, and at both ends ‘a’ and ‘c’ of the frequency. As a result, it was found that the frequency sweep characteristic of the laser light cannot be corrected to be linear in the intervals during which the offset and the ripple occur.

On the other hand, as shown in FIG. 3, when the waveform is continuous at both ends of the beat signal, no offset or ripple occurs. According to the present embodiment, the configuration can accurately measure the frequency sweep characteristic of the laser light. The configuration can also linearly correct the frequency sweep characteristic of the laser light over a wide range.

### Second Embodiment

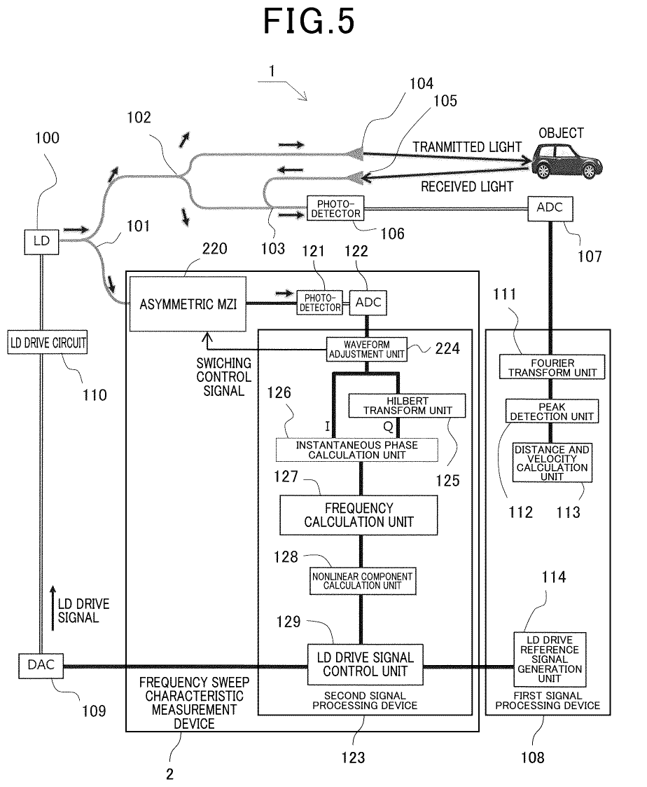

An FMCW-based LiDAR device of the present embodiment has a modified configuration that makes the waveform continuous at both ends of the beat signal in the FMCW-based LiDAR device of the first embodiment. As shown in FIG. 5, the FMCW-based LiDAR device of the present embodiment is the device that the asymmetric MZI 120 and the waveform adjustment unit 124 of the frequency sweep characteristic measurement device 2 in the FMCW-based LiDAR device of the first embodiment changed to an asymmetric MZI 220 and a waveform adjustment unit 224. Other elements are identical to those in the first embodiment.

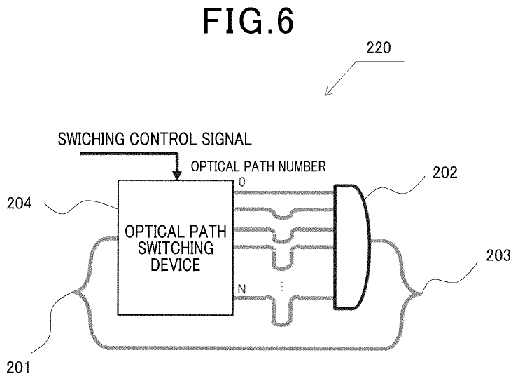

The asymmetric MZI 220 is an asymmetric MZI with a controllable difference ΔL in the lengths of the optical paths. FIG. 6 shows the asymmetric MZI 220 with a mechanism for controlling the difference in the lengths of the optical paths. As shown in FIG. 6, the asymmetric MZI 220 has optical couplers 201 to 203 and an optical path switching device 204.

The optical coupler 201 is an optical device that splits the laser light input from the optical coupler 101 into two laser lights (that is, two light beams). One of the two split laser lights (that is, one of the two split light beams) is input to the optical path switching device 204. The other of the split laser light is input to the optical coupler 203.

The optical path switching device 204 is an optical device that selects one optical path from multiple optical paths that are different in the length from each other and outputs the laser light input from the optical coupler 201 to the selected optical path. The selection of the optical path is controlled by the waveform adjustment unit 224. The optical path switching device 204 may be a switch that combines a multi-mode interference coupler (MMI Coupler) and a phase shifter, or a switch that uses the resonance of a ring resonator. The laser light output from the optical path selected by the optical path switching device 204 is input to the optical coupler 202.

The optical coupler 202 is an optical device that is connected to the multiple optical paths of the optical path switching device 204 and outputs the laser light input from those paths to a single optical path. The optical coupler 202 may be a multimode interference coupler or a star coupler. The laser light output from optical coupler 202 is input to optical coupler 203.

The optical coupler 203 is an optical device that combines the laser light input from optical coupler 201 and the laser light input from the optical coupler 202 to output a combined light. The combined light is input to the photodetector 121.

The waveform adjustment unit 224 generates and outputs a switch control signal to control the selection of the specific optical path in the optical path switching device 204. The waveform adjustment unit 224 outputs the switch control signal to the optical path switching device 204. The optical path switching switch device 204 selects then the specific optical path from the multiple optical paths based on the input switch control signal. As a result, the waveform adjustment unit 224 adjusts the waveform so that the waveform is continuous at both ends of the beat signal. Specifically, the waveform adjustment unit 224 generates the switch control signal for controlling the optical path switching device 204 as follows and controls the selection of the specific optical path in the optical path switching device 204 based on the generated control signal.

As shown in FIG. 6, there are N+1 lines of the optical paths selected by the optical path switching device 204 in the present embodiment. The number identifying the selected optical path (optical path number) is 0, 1, . . . , i, . . . , N in order of the short length of the optical path. The waveform adjustment unit 124 outputs the switch control signal for selecting the (i)-th optical path to the optical path switching device 204. The optical path switching device 204 selects then the (i)-th optical path based on the input switch control signal.

Here, an increasing length of the optical path, that is, an extension length (a difference between a length of the (i)-th optical path and a length of the (i+1)-th optical path), should be less than or equal to r/2 when a range of the difference in the lengths of the optical paths where no offset or ripple occurs (that is, the difference in the lengths of the optical paths where a maximum value of the nonlinear component νnl(t) of the instantaneous frequency is minimized) is r.

First, the waveform adjustment unit 224 removes the high-frequency noise from the beat signal input from the AD converter 122 by moving average. The waveform adjustment unit 224 then detects the error δ at both ends of the beat signal (the difference between the amplitudes at both ends).

Next, the waveform adjustment unit 224 determines whether the absolute value of the error δ is less than or equal to a predetermined value. The error δ allows it to be set so that the waveform is continuous at both ends of the beat signal. For example, the error δ is set such that the absolute value of the difference between the amplitudes of both ends of the beat signal is less than or equal to 1% of a maximum amplitude.

When the waveform adjustment unit 224 determines that the absolute value of the error δ is less than or equal to the predetermined value, it does not update the switch control signal and outputs the beat signal to the Hilbert transform unit 125 and the instantaneous phase calculation unit 126.

On the other hand, when the waveform adjustment unit 224 determines that the absolute value of the error δ is greater than the predetermined value, the waveform adjustment unit 224 calculates the derivative values a1 and a2 at both ends of the beat signal. The waveform adjustment unit 224 then calculates a value expressed as sgn{δ×sgn (a1·a2)}.

Next, the waveform adjustment unit 224 updates the switch control signal to select the (i)-th optical path as i=i+sgn{δ×sgn(a1·a2)}. The waveform adjustment unit 224 repeats updating the switch control signal until the absolute value of the error δ is determined to be less than or equal to the predetermined value.

The method for updating the switch control signal is not limited to the above method. The method for updating the switch control signal may be, for example, simply increasing i by one and repeating until the absolute value of the error δ at both ends of the beat signal is determined to be less than or equal to the predetermined value.

As described above, in the frequency sweep characteristic measurement device 2 of the present embodiment, the asymmetric MZI 220 with the controllable difference in the lengths of the optical paths is used to adjust the waveform so that the waveform is continuous at both ends of the beat signal by controlling the difference in the lengths of the optical paths by the waveform adjustment unit 224.

Next, an analysis result of the beat signal analysis for the present embodiment is explained.

In the present embodiment, the beat signal was generated with the rate of change of the frequency of γ=1.0 GHz/125 μs and the nonlinear component of the instantaneous frequency of νnl(t)=9×10⁵·sin[2π·4×10³ t]. The maximum value of the nonlinear component νnl of the instantaneous frequency was then calculated by sweeping the difference ΔL in the lengths of the optical paths in the asymmetric MZI 220, which was controlled by the waveform adjustment unit 224.

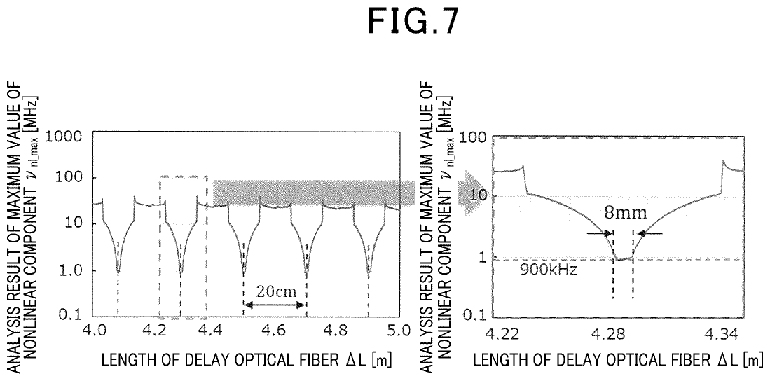

FIG. 7 shows the relationship between the difference ΔL in the lengths of the optical paths (length of the delay optical fiber) and the maximum value of the nonlinear component νnl of instantaneous frequency. As shown in FIG. 7, a peak at which the maximum value of the nonlinear component νnl becomes smaller appears about every 20 cm. A range of the difference in the lengths of the optical paths at which the maximum value of the nonlinear component νnl becomes smallest was found to be about 8 mm. When the maximum value of the nonlinear component νnl is outside the range (8 mm) of the difference in the lengths of the optical paths where the maximum value of the nonlinear component νnl is minimized, the maximum value of the nonlinear component νnl increases by more than one order of magnitude. This is because the measurement error occurs by increasing the offset due to the waveform being discontinuous at both ends of the beat signal. In this case, it was found that the increasing length of the optical path in the asymmetric MZI 220, that is, the extension length, is preferable to be less than or equal to 4 mm (=8/2).

If an effective refractive index of an optical fiber is 1.46, the time required for the light to pass through an 8 mm length of the optical fiber is about 39 ps. Therefore, it was found that, when the propagation delay time is controlled to become within the range of 39 ps in the asymmetric MZI 220, the waveform can be made continuous at both ends of the beat signal to reduce the measurement error.

### Other Embodiments

Although each of the above embodiments indicates a configuration example of applying the frequency sweep characteristic measurement device of the present disclosure to an FMCW-based LiDAR device, the frequency sweep characteristic measurement device of the present disclosure can be applied to any device that requires a measurement of the frequency sweep characteristic. For example, the frequency sweep characteristic measurement device of the present disclosure may be applied to a spectrometer. In addition, each of the above embodiments is for the case where the frequency is swept to be linear, but the techniques of the present disclosure can also be applied to cases where the frequency is swept to be other than linear.

The present disclosure has been described in accordance with embodiments. However, it is understood that the present disclosure is not limited to the embodiments and configurations. The present disclosure also encompasses various variation examples or variations within the equivalent scope. In addition, various combinations and forms, and furthermore, other combinations and forms that include only one component, more than that, or less than that, in the various combinations or embodiments also fall within the category or conceptual scope of the present disclosure.

What is claimed is:

1. A frequency sweep characteristic measurement device for measuring a frequency sweep characteristic of a laser light in which a frequency is swept, the device comprising,
an asymmetric Mach-Zehnder interferometer that splits the laser light to generate a difference in lengths of optical paths and combines the split laser lights to generate a combined light,
a photodetector that receives the combined light output from the asymmetric Mach-Zehnder interferometer, converts the received light into a beat signal as an electrical signal, and outputs the beat signal,
a waveform adjustment unit that adjusts a waveform so that an amplitude and a phase match at both ends of the beat signal,
a Hilbert transform unit that calculates a quadrature component by performing a Hilbert transform on the beat signal whose waveform has been adjusted,
an instantaneous phase calculation unit that calculates an instantaneous phase of the beat signal by calculating an inverse tangent of the quadrature component calculated by performing the Hilbert transform and the beat signal whose waveform has been adjusted, and
a frequency calculation unit that calculates the frequency sweep characteristic of the laser light based on the instantaneous phase and the difference in the lengths of the optical paths.

2. The frequency sweep characteristic measurement device according to claim 1, wherein,
the waveform adjustment unit, to adjust the waveform so that the amplitude and the phase match at both ends of the beat signal,
extracts two adjacent zero-crossing points in a vicinity of both ends of the beat signal, respectively,
calculates derivative values of the beat signal at the four extracted zero-crossing points,
selects two points of the four extracted zero-crossing points where signs of the calculated derivative values match each other, and
deletes measurement points outside the two selected points from the beat signal.

3. The frequency sweep characteristic measurement device according to claim 1, wherein,
the asymmetric Mach-Zehnder interferometer is configured such that the difference in the lengths of the optical paths is controllable,
the waveform adjustment unit, to adjust the waveform so that the amplitude and the phase at both ends of the beat signal match, controls the difference in the lengths of the optical paths.

4. The frequency sweep characteristic measurement device according to claim 3, wherein,
the asymmetric Mach-Zehnder interferometer comprises an optical path switching device that switches multiple optical paths that are the different in the length of the optical path from each other, and is configured such that the difference in the lengths of the optical paths is controllable by the optical path switching device switching the multiple optical paths, and
the waveform adjustment unit, to adjust the waveform so that the amplitude and the phase at both ends of the beat signal match, controls the selection of the optical path by optical path switching device.

5. An FMCW-based LiDAR device comprising,
a laser diode emitting a laser light, and
a frequency sweep characteristic measurement device as claimed in claim 1,
wherein,
the drive signal control unit, to reduce a nonlinear component of the laser light, calibrates a drive signal of the laser diode based on the frequency sweep characteristic of the laser light calculated by the frequency calculation unit.

6. A frequency sweep characteristic measurement method for measuring a frequency sweep characteristic of a laser light in which a frequency is swept, the method comprising,
splitting the laser light to generate a difference in lengths of optical paths and combining the split laser lights to generate a combined light,
receiving the combined light, converting the received light into a beat signal as an electrical signal, and outputting the beat signal,
adjusting a waveform so that an amplitude and a phase match at both ends of the beat signal,
calculating a quadrature component by performing a Hilbert transform on the beat signal whose waveform has been adjusted,
calculating an instantaneous phase of the beat signal by calculating an inverse tangent of the quadrature component calculated by performing the Hilbert transform and the beat signal whose waveform has been adjusted, and
calculating the frequency sweep characteristic of the laser light based on the instantaneous phase and the difference in the lengths of the optical paths.
